(19) United States
(12) Patent Application Publication
(10) Pub. No.: US 2025/0087045 A1
(43) Pub. Date: Mar. 13, 2025

(54) DISPLAY ASSEMBLIES FOR A GAMING DEVICE HAVING A CURVED EDGE

(71) Applicant: Aristocrat Technologies, Inc., Las Vegas, NV (US)

(72) Inventors: Charles Miller, SR., Henderson, NV (US); Michael Baum, Las Vegas, NV (US); Rajendrasinh Jadeja, Las Vegas, NV (US)

(21) Appl. No.: 18/818,972

(22) Filed: Aug. 29, 2024

Related U.S. Application Data
(60) Provisional application No. 63/582,466, filed on Sep. 13, 2023.

(51) Int. Cl. G07F 17/32; G02F 1/1333; G02F 1/1343; G02F 1/1368

(52) U.S. Cl. CPC G07F 17/3211; G02F 1/133308; G02F 1/134309; G02F 1/1368; G07F 17/3216; G02F 2201/56; G07F 17/3267

(57) ABSTRACT

A gaming device includes a cabinet and a display assembly coupled to the cabinet and configured to display a game thereon. The display assembly includes a display frame and a display panel positioned within the display frame. The display panel includes an outer display surface, a rear panel layer including a plurality of transistors coupled to a substrate, and a liquid crystal layer positioned between the rear panel layer and the outer display surface, wherein the outer display surface includes a pair of opposed elongated edges and a first curved edge extending between the elongated edges.

### CROSS-REFERENCE TO RELATED APPLICATIONS

This application claims priority to U.S. Provisional Patent Application No. 63/582,466, filed Sep. 13, 2023, the disclosure of which is hereby incorporated by reference in its entirety.

### TECHNICAL FIELD

The field of disclosure relates generally to electronic gaming devices, and more particularly, to a gaming device having a display assembly with a curved edge display panel.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming device includes a cabinet and a display assembly coupled to the cabinet and configured to display a game thereon. The display assembly includes a display frame and a display panel positioned within the display frame. The display panel includes an outer display surface, a rear panel layer including a plurality of transistors coupled to a substrate, and a liquid crystal layer positioned between the rear panel layer and the outer display surface, wherein the outer display surface includes a pair of opposed elongated edges and a first curved edge extending between the elongated edges.

In another aspect, a display panel for use with an electronic gaming machine includes an outer display surface, a rear panel layer including a plurality of transistors coupled to a substrate, and a liquid crystal layer positioned between the rear panel layer and the outer display surface. The outer display surface includes a pair of opposed elongated edges and a first curved edge extending between the elongated edges.

In yet another aspect, a method of forming a display panel for use with an electronic gaming machine includes providing an outer display surface and a rear panel layer. The rear panel layer includes a plurality of transistors coupled to a substrate. The method further includes coupling a liquid crystal layer to the rear panel layer and the outer display surface with the liquid crystal layer being positioned between the rear panel layer and the outer display surface. The outer display surface includes a pair of opposed elongated edges and a first curved edge extending between the elongated edges.

### BRIEF DESCRIPTION OF THE DRAWINGS

FIG. 1 is an exemplary diagram showing several gaming machines networked with various gaming-related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a front view of a gaming device according to an embodiment of the present disclosure and similar to the EGMs shown in FIG. 1.

FIG. 5 is front schematic view of a display assembly of the gaming device shown in FIG. 4.

FIG. 6 is an exploded schematic view of the display assembly shown in FIG. 5.

FIG. 7 is a front view of another gaming device according to an alternative embodiment of the present disclosure and similar to the EGMs shown in FIGS. 1 and 4.

FIG. 8 is a front view of another gaming device according to an alternative embodiment of the present disclosure and similar to the EGMs shown in FIGS. 1, 4, and 7.

FIG. 9 is a front schematic view of an alternative display panel for use with the gaming devices of any one of FIGS. 1, 4, 7, and 8.

FIG. 10 is a front schematic view of a portion of the display panel shown in FIG. 9, showing the region A shown in FIG. 9.

### DETAILED DESCRIPTION

The systems and methods described herein include a gaming device that includes a display assembly having a liquid crystal display (“LCD”) panel with an outer display surface, a rear panel layer including a plurality transistors coupled to a substrate, and a liquid crystal layer positioned between the rear panel layer and the outer display surface, where the outer display surface includes an elongated edge and a curved edge extending from the elongated edge. As a result, the LCD panel provides a differentiating and visually appealing aesthetic appearance to players on a gaming floor. Additionally, the display panel may server as a template for manufacture of different display panels from the display panel template. As an example, the display panel may have a stadium shaped profile, including a rectangular section connecting a pair of semicircular sections positioned at opposed ends of the panel. As a result, the display panel may be cut, during or after assembly of the display panel, to form two functioning display panels from the stadium shaped profile, each including a curved edge.

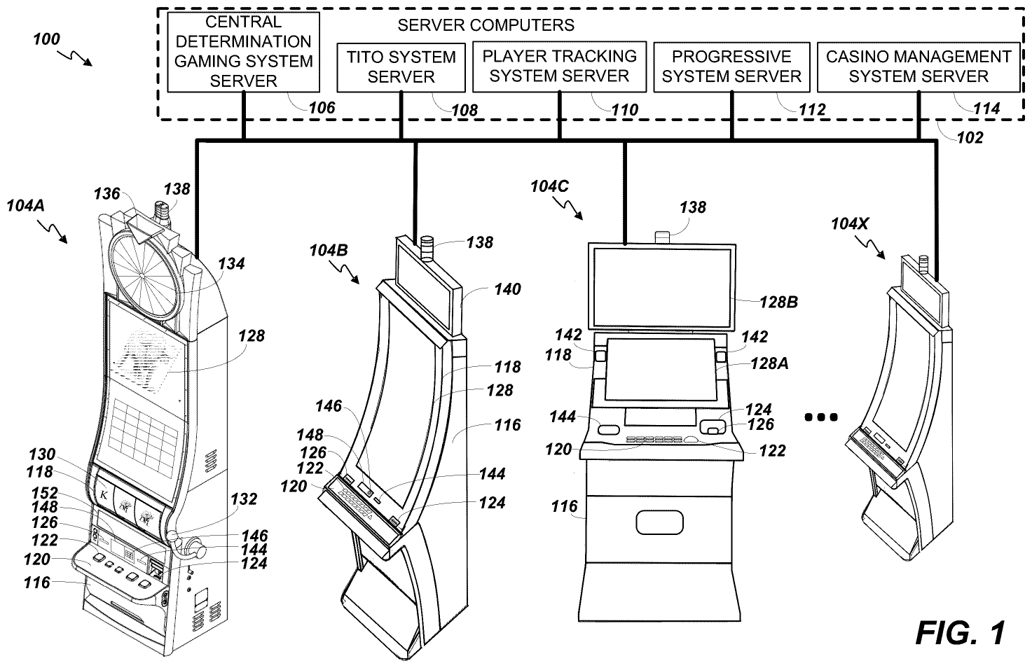

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XLT™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, and/or total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

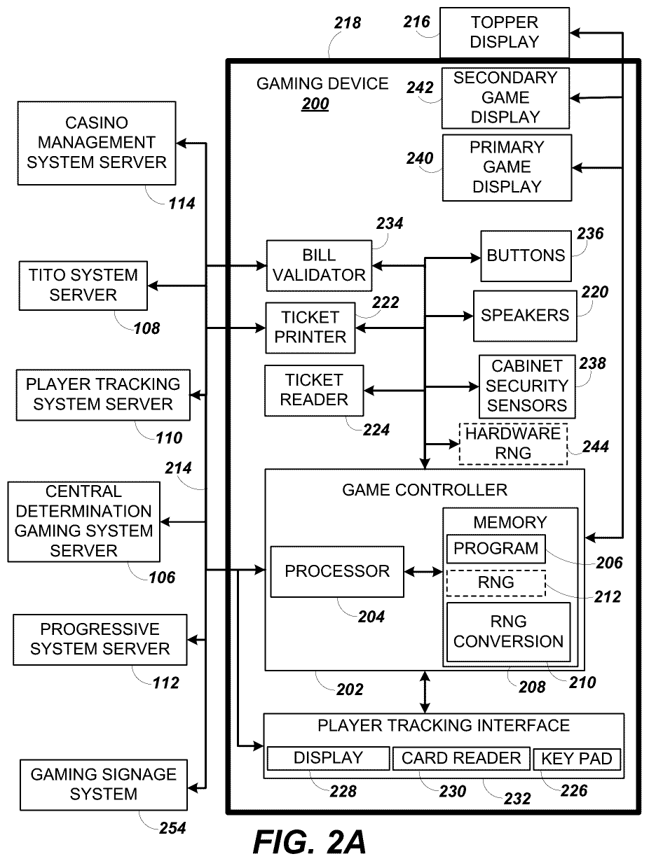

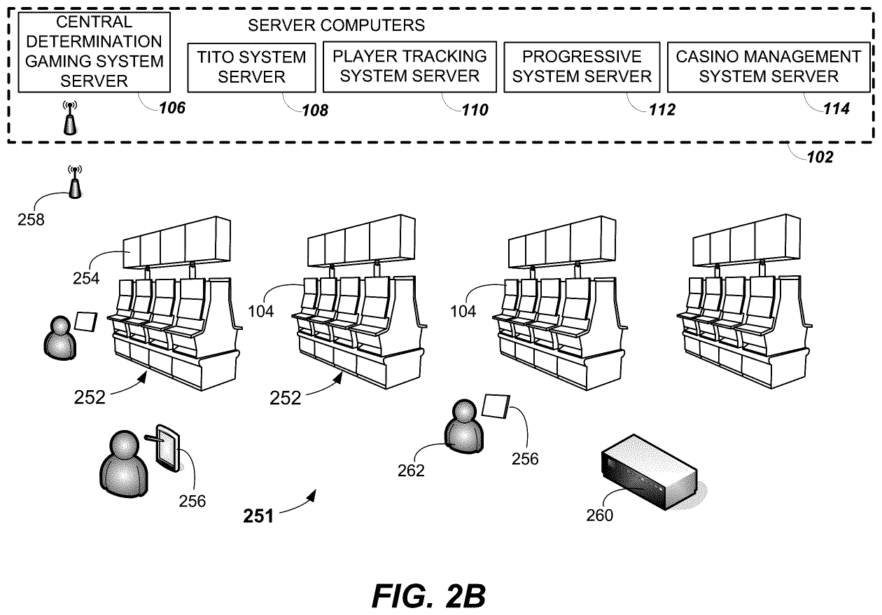

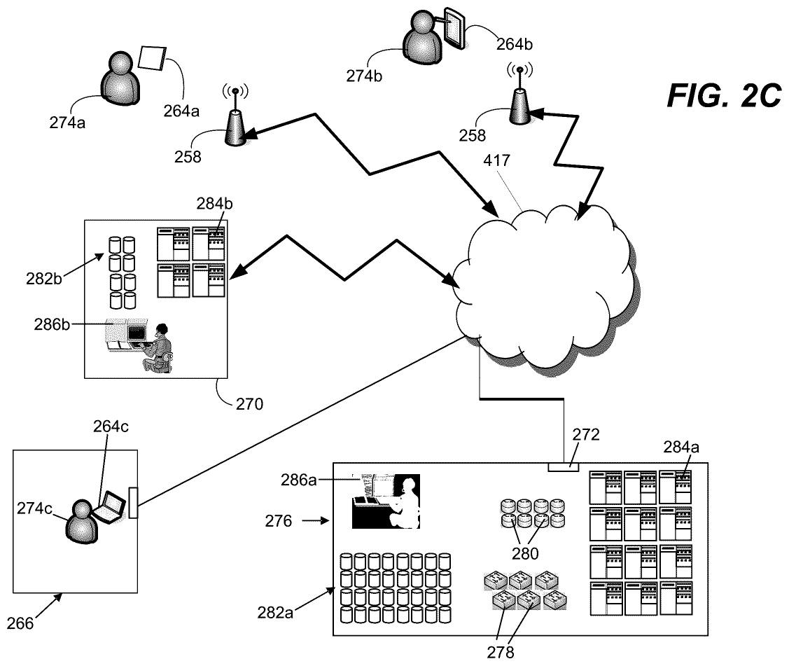

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

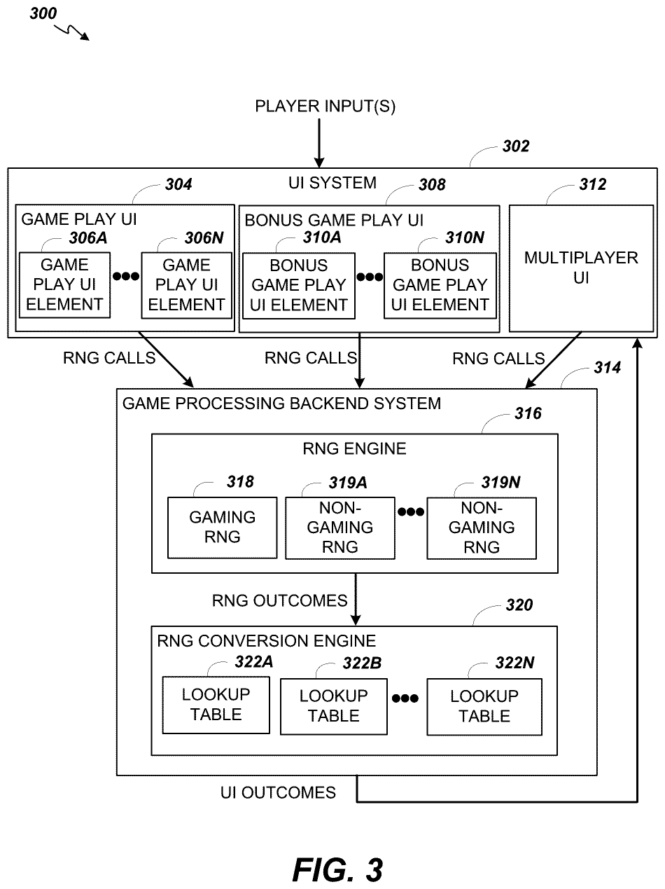

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

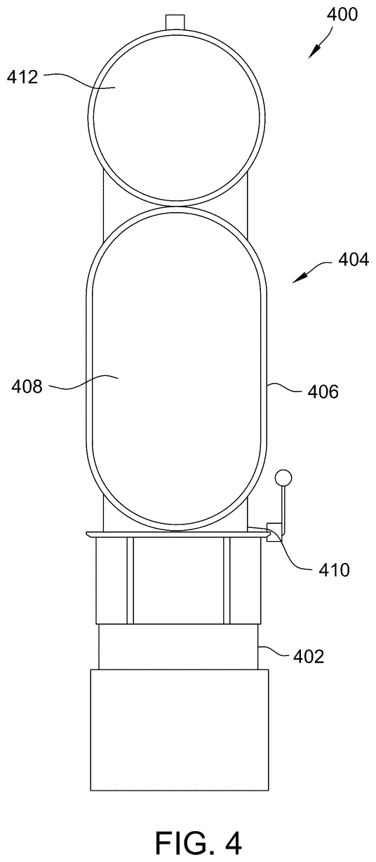

FIGS. 4-6 depict an example gaming device 400 and a display assembly 404 of the gaming device 400, which in some embodiments, may be an implementation of gaming devices 104A-104X described with respect to FIG. 1.

As shown in FIG. 4, the electronic gaming device or “gaming device” 400 includes a cabinet 402 and a display assembly 404 coupled to the cabinet 402, which may display a gaming interface to a user. The display assembly 404 includes a display frame 406 and a display panel 408 housed at least partially within the display frame 406. The gaming device 400 further includes a button deck 410 including one or more buttons (not shown) that may be used for interacting with gaming device 400. The display frame 406 is coupled to the cabinet 402 of the gaming device 400 such that the cabinet 402 supports the display assembly 404 above the button deck 410.

The gaming device 400 further includes a second or “topper” display 412 (also referred to as a “marquee display”) coupled to the cabinet 402 and positioned above the display assembly 404. The topper display 412 may be programmed to display one or more indicators associated with a game played at the gaming device 400, such as, but not limited to, a current jackpot award amount. In other embodiments the gaming device 400 does not include the topper display 412.

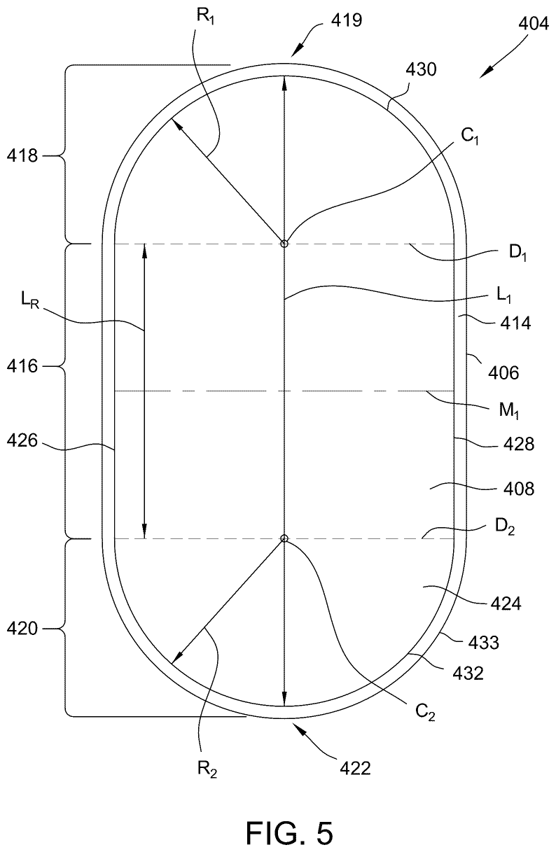

FIG. 5 is a schematic front view of the display assembly 404 shown in FIG. 4.

In the example embodiment, the display frame 406 and the display panel 408 each have a complementary shape such that the display panel 408 is inscribed within the display frame 406, and particularly a bezel 414 of the display frame 406, as shown in FIG. 5. The bezel 414 is annular and extends entirely around a perimeter of the display panel 408. In some embodiments, at least a portion of the display panel 408 may extend at least partially within or otherwise overlap the bezel 414.

The display panel 408 has a “stadium” or partially oval profile shape. The shape of the display panel 408 may alternatively be referred to herein as “curvilinear”. In particular, the display panel 408 includes a rectangular mid-section 416, a first semicircular section 418 at a first end 419 of the display panel 408, and a second semicircular section 420 at a second end 422 of the display panel 408, wherein the first end 419 may be at an end opposed to the second end 422, as depicted in FIG. 5. The rectangular section 416 extends from the first semicircular section 418 to the second semicircular section 420 such that the first semicircular section 418, the second semicircular section 420, and the rectangular section 416 collectively define a continuous planar display surface 424. In other words, the display panel 408 does not include bezels separating the differently shaped sections 416, 418, 420 of the display panel 408. The display surface 424 of the display panel 408 extends to the bezel 414, with the bezel 414 bordering the display surface 424 around an entire perimeter of the display surface 424. In other embodiments, at least a portion of the display surface 424 may extend at least partially within or otherwise overlap the bezel 414. For example, and without limitation, in some embodiments the display surface 424 extends to an outer edge 433 of the bezel 414, either beneath or on top of the bezel 414.

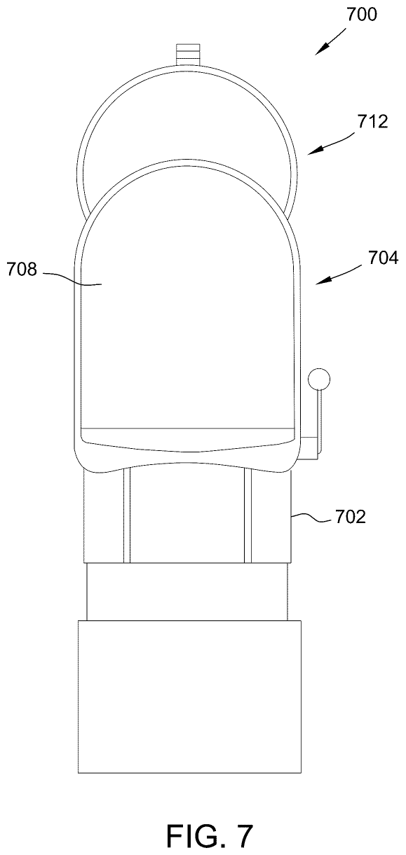

The rectangular section 416 of the display panel 408 is defined by a first linear or “elongated” edge 426 and a second, opposed linear edge 428. The first semicircular section 418 is defined by a first “arced” or “curved” (terms used interchangeably herein) edge 430 that extends from the first linear edge 426 to the second linear edge 428 at the first end 419 of the display panel 408. The second semicircular section 420 is defined by a second curved edge 432 that extends from the first linear edge 426 to the second linear edge 428 at the second end 422 of the display panel 408. The curved edges 430, 432 are each coplanar with the elongate edges 426,428. In other embodiments, one or more of the curved edges 430, 432 and elongate edges 426, 428 may be non-coplanar with one or more of the other edges. For example, in some embodiments, at least a portion of the display panel 408 may curve outward at toward and/or away from a player. As described in greater detail below with respect to FIG. 7, in some embodiments the display panel 408 has a semi-stadium shape and does not include one of the first and second semicircular sections 418, 420.

The first linear edge 426 and the second linear edge 428 of the rectangular section define a first length L_{R} of the rectangular section 416, extending from the first curved edge 430 to the second curved edge 432. The rectangular section 416 further defines a first width W₁, extending between the first linear edge 426 and the second linear edge 428. In other embodiments, the first linear edge 426 and/or the second linear edge 428 may be at least partially curved. For example, in embodiments where the display panel 408 has an oval shape, the first linear edge 426 and second linear edge 428 are elongated edges, having a radius of curvature that is different from a radius of curvature of the first curved edge 430 and the second curved edge 432.

The display assembly 404 is configured to be coupled to the cabinet 402, as shown in FIG. 4, such that the first linear edge 426 and the second linear edge 428 extend generally in a vertical direction. In other embodiments, the display assembly 404 may be coupled to the cabinet 402, or mounted to any other suitable structure, in any suitable orientation. For example, and without limitation, in some embodiments, the display assembly 404 is oriented such that the first linear edge 426 and the second linear edge 428 extend generally horizontally.

In the example embodiment, the first curved edge 430 and the second curved edge 432 each have a generally constant curvature. For example, the first semicircular section 418 defines a first center point C₁ and a first radius R₁ extending from the first center point C₁ to the first curved edge 430. The first radius R₁ is generally the same along an entire length of the first curved edge 430. Additionally, in the example embodiment, the first radius R₁ is equal to approximately half of the first width W₁ of the rectangular section 416 and a first diameter D¹ of the first semicircular section 418 is approximately equal to the first width W₁ of the rectangular section 416. Similarly, the second curved edge 432 has a curvature that is substantially the same as the first curved edge 430 and has a second radius R₂ extending from a second center point C₂ that is substantially equal to the first radius R₁.

In other embodiments, the first curved edge 430 and the second curved edge 432 may have any suitable curvature. For example, in some embodiments, the first curved edge 430 and the second curved edge 432 may have different curvatures from one another. Moreover, in some embodiments, the curvatures of at least one of the first curved edge 430 and the second curved edge 432 are not constant, such that a radius of curvature of the respective curved edges 430, 432 changes along a length of the curved edge 430, 432.

In the example embodiment, the display panel 408 has a total length L₁ defined by a line extending from the first curved edge 430 to the second curved edge 432 and through the first center point C₁ and the second center point C₂. The total length L₁ of the display panel 408 is equal to the sum of the length Lᵣ of the rectangular section 416, the first radius R₁, and the second radius R₂. A longitudinal midline M₁ of the panel 408 is defined at approximately a halfway point of the total length L₁ of the display panel 408 and extends from the first linear edge 426 to the second linear edge 428. The display panel 408 is sized and shaped such that the midline M₁ evenly divides a total surface area of the display surface 424. In other words, referring to FIG. 5, half of the surface area of the display surface 424 is above the midline M₁ and half of the surface area of the display surface 424 is below the midline M₁.

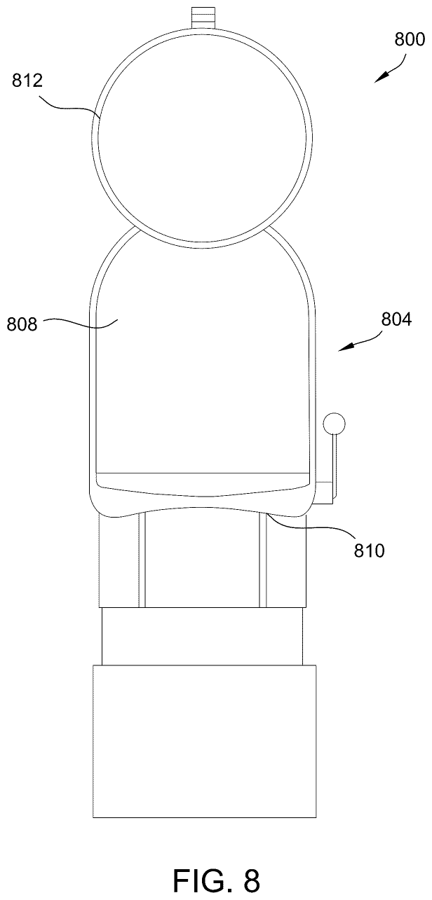

In the example embodiment, the display panel 408 is configured to be cut (e.g., during manufacture or assembly) along the midline M₁ to provide two separate and functioning display panels. The display panel 408 may also be referred to as a “template” or “template panel”, in that it may be used with a gaming machine 400 as a single panel, as shown with respect to FIG. 4, or it may be cut to form multiple panels of different sizes from the template panel, such as the panel 708 shown in FIG. 7. The display panel 408 may also be cut along at least one of the diameter lines D₁, D₂ for forming a different sized display panel, such as the display panel 808 shown in FIG. 8. In some embodiments, the display panel 408 is further configured to be cut in a vertical direction, such as along the total length line L₁ shown in FIG. 5.

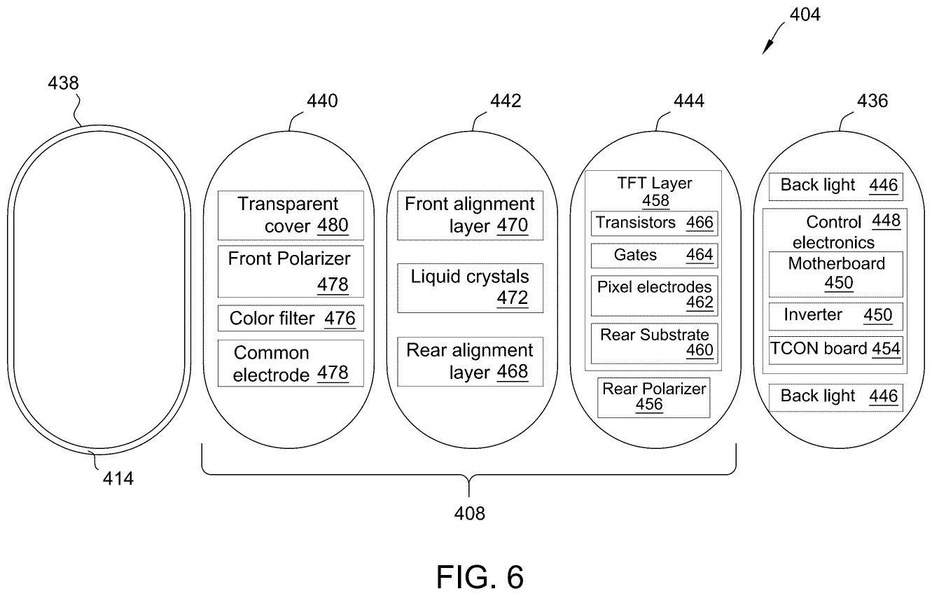

FIG. 6 is a schematic diagram showing layers of the display assembly 404, shown in FIG. 5. In the example embodiment, the display assembly 404 includes a base frame 436 and an outer frame 438 configured to be coupled to the base frame 436. The outer frame 438 and the base frame 436 collectively define the display frame 406 (shown in FIG. 5) of the display assembly 404. The display assembly 404 further includes a front panel layer 440, a liquid crystal layer 442, and a rear panel layer 444 that are coupled to the display frame 406 and positioned between the outer frame 438 and the base frame 436. The base frame 436 may be a modifiable substrate, wherein the modifiable substrate has at least one portion that can be excised for use as another component for incorporation into an electronic gaming machine. More particularly, the modifiable substrate can involve strategic customization of the display and the circuit placement, such that the display assembly 404 and/or display panel 408 can be cut from one or more locations to yield the excised sections. The cut panels can be used for toppers, button deck and/or main display, based on the cabinet properties, such as curvatures and cavities therein. Currently, if shelf display panels are cut, the remaining material is wasted and costs are costs are higher.

The layers 440, 442, and 444 collectively define the display panel 408 and are illustrated schematically. For example, components of the layers 440, 442, 444 may not necessarily be provided on a single layer (i.e., on a single substrate). Additionally with respect to the display panel 408, the four corners of these curvilinear display may be configured to: (1) place components, i.e., bill validator and ticket printer on bottom left and right and maybe speakers on top left and right; and (2) support a stacked landscape dual display for component placement and accenting the cabinet appearance and features. Hence, this leads to a more ergonomic cabinet, while maintaining the visual display canvas.

The display assembly 404 includes at least one back light 446 (two shown in FIG. 6) and control electronics 448 coupled to the base frame 436. The control electronics 448 include a motherboard 450, a power inverter 452, and a timing controller board 454 (“TCON board”). The inverter 452 receives power from a power source, such as a battery and/or an external power source (not shown) and provides a voltage to the motherboard 450, the TCON board 454, and the back light 446. The back light 446 generates light to be projected through the layers 440, 442, and 444.

The display panel 408 of the example embodiment is a thin film transistor (“TFT”) liquid crystal display (“LCD”). The rear panel layer 444 includes a rear polarizer 456 and a TFT layer 458 positioned between the rear polarizer 456 and the liquid crystal layer 442.

The TFT layer 458 includes a rear substrate 460, transparent pixel electrodes 462, gates 464, and transistors 466. The rear substrate 460 is a transparent substrate, such as a glass or transparent laminate, and the pixel electrodes 462, gates 464, and transistors 466, are each provided on the rear substrate 460. In some embodiments, the rear panel layer 444 or portions of the rear panel layer 444 are formed using a photomask corresponding to the shape of the display panel 408. Each pixel of the pixel electrodes 462 is paired with a transistor 466 and gates 464, which control opacity of the pixel electrodes 462 for selectively controlling whether individual pixels are illuminated.

The liquid crystal layer 442 is positioned between the front panel layer 440 and the rear panel layer 444. The liquid crystal layer 442 includes a rear alignment layer 468, a front alignment layer 470, and a liquid crystal medium 472 positioned between the rear alignment layer 468 and the front alignment layer 470.

The front panel layer 440 is positioned outside of the liquid crystal layer 442 and includes a common electrode 474, a color filter 476, a front polarizer 478, and a transparent cover 480. The color filter 476 is positioned between the front polarizer 478 and the common electrode 474 and is a red-blue-green (“RGB”) color filter. The transparent cover 480 may be a glass substrate and defines the display surface 424 (shown in FIG. 5) of the display panel 408. The transparent cover 480 may extend at least partially over the bezel 414 of the outer frame 438 or the transparent cover 480 may be positioned entirely within the bezel 414.

The description of certain display assembly components herein is schematic and not limiting of the display assembly 404. For example, in other embodiments, the display assembly 404 may include other layers, such as diffusers. Additionally the base frame 436 and/or the outer frame 438 may include a plurality of additional frame components (not shown).

In the example embodiment, the rear polarizer 456, the TFT layer 458, the rear alignment layer 468, the liquid crystal layer 442, the front alignment layer 470, the common electrode 474, the color filter 476, the front polarizer 478, and the transparent cover 480 each have substantially the same stadium shape and size, as described with respect to display panel 408 generally in FIG. 5.

As described above with respect to FIG. 5, the display assembly 404 and/or components of the display assembly 404 are arranged to facilitate cutting the display assembly along the midline M_{L} (shown in FIG. 5) during manufacture and after forming (e.g., by using a photomask) the display panel layers 440, 442, and 444. For example, the transistors 466, gates 464, and pixel electrodes 462 are each arranged on the rear substrate 460 such that cutting the rear substrate 460 at the midline M_{L} does not sever, obstruct, or otherwise interfere with operation of the TFT layer 458. Additionally, the control electronics 448 are positionable on the base frame 436 such that cutting the display assembly 404 along the midline M_{L} does not cross or otherwise interfere with the control electronics 448. For example, where the display panel 408 is cut to form two separate displays (e.g., as shown in FIG. 7), a correspondingly sized and shaped display frame may be used and additional control electronics 448 may be provided for controlling the second display assembly 404.

FIG. 7 is a front view of an alternative gaming device 700. The gaming device 700 of FIG. 7 is substantially the same as the gaming device 400 of FIG. 4 except that the gaming device 700 of FIG. 7 includes a display assembly 704, that is formed by cutting the display panel 408 of FIG. 5 along the midline M_{L}, shown in FIG. 5, thereby modifying the display surface of display assembly 704 in relation to the display surface 424. A topper display 712 may be a circular display which: 1) resides behind the display assembly 704, wherein the display assembly 704 may be smaller than the display assembly described above; and 2) has a larger or smaller radius than the first semicircular section 418 or the second semicircular section 420. In other embodiments, the topper display 712 may be sized and shaped in relation to the display panel 708 such that the topper display 712 curves inward in correspondence with the first semicircular section 418 of the display panel 708. Additionally or alternatively, the topper display 712 may be coupled to the cabinet 702 by an extendable arm (not shown) that is moveable along the “z-direction” (i.e., “behind the plane of paper and in front of the plane of the paper”) or “y-direction” (i.e., vertical direction within the plane of the paper) relative to the cabinet 702. In such embodiments the extendable arm may raise or lower the topper display 712 on the cabinet 702.

FIG. 8 is a front view of another alternative gaming device 800. The gaming device 800 of FIG. 8 is substantially the same as the gaming device 400 of FIG. 4 except that the gaming device 800 of FIG. 8 includes a modified display assembly 804 that is smaller than the display assembly 404 of FIG. 4 and larger than the display assembly 704 of FIG. 7. The display assembly 804 is formed by cutting the display panel 408 of FIG. 5 along the second diameter line D₂, shown in FIG. 5. That is, referring to FIG. 5, the display panel 808 of FIG. 8 includes only the rectangular section 416 and the first semicircular section 418 and does not include the second semicircular section 420.

In some embodiments, the second semicircular section 420 may be repurposed for use as an additional display on the gaming device 800. For example, in some embodiments, the additional display including the second semicircular section 420 (shown in FIG. 5) may be provided on the button deck 810 of the gaming device 800 and/or may be used as an alternative topper display 812 to form display arrangements, such as arrangements 1-3 described herein to engage a player or other patrons. In the first arrangement, the topper display 812 extends in a vertical direction or “y-direction” (terms used interchangeably herein) past the display panel 808 and partially behind a top portion of the display 808, such that the top portion of the display panel 808 is positioned in front of the topper display 812. In a second arrangement, the topper display 812 extends in the y-direction past the display panel 808 and is positioned in front of a top portion of the display panel 808. In a third arrangement, the topper display 812 is configured to be received by a portion of perimeter of display panel 808 curving inwards towards M_{L} such that: (i) the curvature appears concave up, (ii) the left and right curved edges of first semicircle section 418 are concave down. Transparent components can optionally be integrated onto the top edge of the display panel 804 to enhance the visual features of view 1, view 2, and view 3. In arrangements 1-3, topper display 812 and display panel 808 may form an edge arrangement that is concave down in the left-handed portion, concave up in the center, and concave down in the right-hand portion of the display panel 804, based on the curvatures and relative positions of topper display 812 and display panel 808, such that the edge arrangement may appear as, for example, a continuous black perimeter. In embodiments where the display panel 808 curves inward, the inward curve may be formed by cutting the display panel 408 of FIG. 5 at the first end 419, thereby modifying the display surface of display panel 808 in relation to the display surface 424.

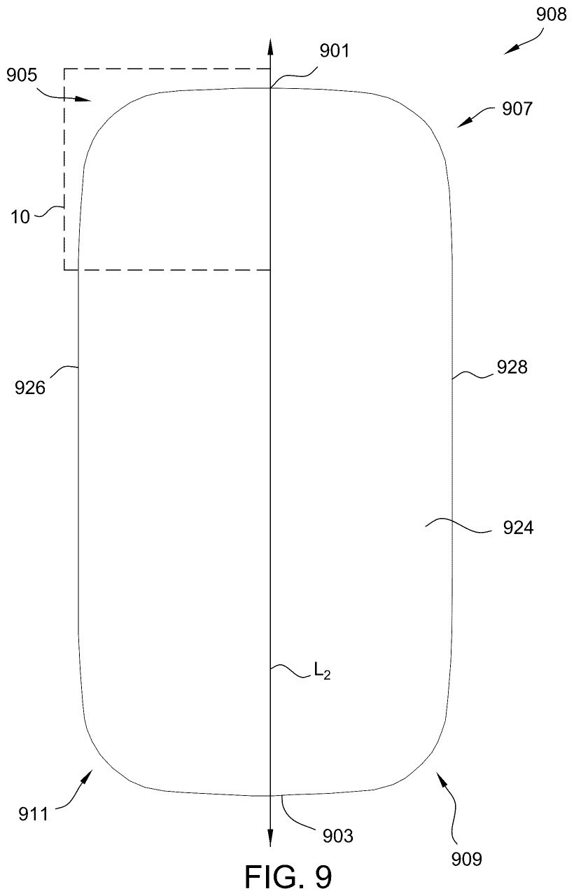

FIG. 9 is a front schematic view of an alternative display panel 908 for use with the gaming devices of any one of FIGS. 1, 4, 7, and 8. The display panel 908 is substantially the same as the display panel 408 shown in FIG. 5, except that, the display panel 908 of FIG. 9 has an alternative shape in the form of a rounded corner parallelogram. While only the display panel 908 is shown in FIG. 9, it should be understood that the display panel 908 may form part of a display assembly including a display frame (not shown) that is substantially similar to the display frame 406 (shown in FIG. 4), except being sized and shaped in correspondence with the size and shape of the display panel 908.

Referring to FIG. 9, in the example embodiment the display panel 908 includes an outer display surface 924 including first end edge 901, a second end edge 903, a first side edge 926, and a second side edge 928. The panel 908 defines a longitudinal axis L₂ extending through the first end edge 901 and the second end edge 903. The first end edge 901 and the second end edge 903 are positioned at opposed longitudinal ends of the panel 908. The first side edge 926 and the second side edge 928 are positioned at opposed lateral sides of the panel 908. The surface 924 extends continuously between the end edges 901, 903 and side edges 926, 928 of the panel 908

In the example embodiment, each of the end edges 901, 903 and side edges 926, 928 are generally linear. The first side edge 926 and the second side edge 928 are oriented in parallel with one another. The first end edge 901 and the second end edge 903 are likewise oriented in parallel with one another and are each oriented perpendicular to the first side edge 926 and the second side edge 928. In other embodiments at least one of the side edges 926, 928 and end edges 901, 903 may be at least partially curved.

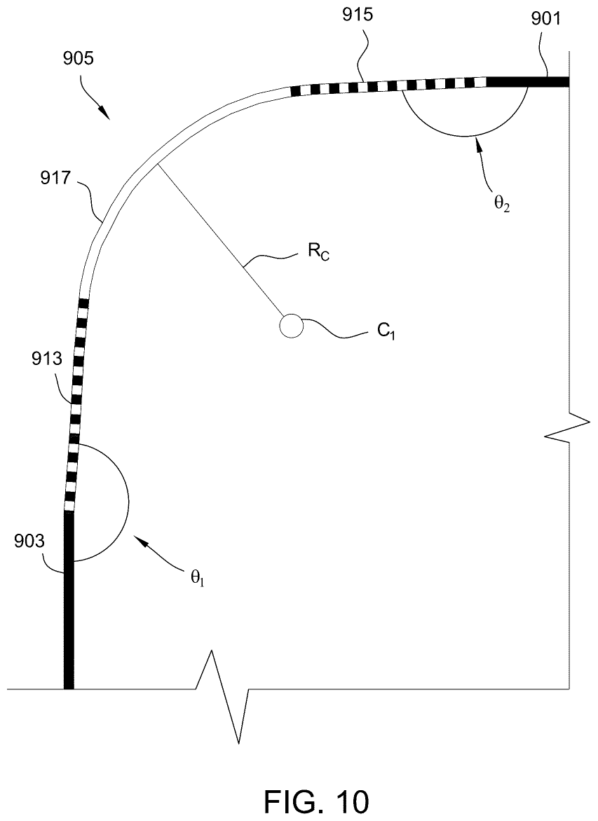

In the example embodiment, the display panel 908 further includes a plurality of corner portions including a first corner portion 905, a second corner portion 907, a third corner portion 909 and a fourth corner portion 911. Each of the corner portions 905, 907, 909, 911 extends between one of the end edges 901, 903 and one of the side edges 926, 928. The corner portions 905, 907, 909, 911 are each at least partially curved, as described in greater detail below with respect to FIG. 10.

FIG. 10 is an enlarged front schematic view of the region A of the display panel shown in FIG. 9. FIG. 10 shows the first corner portion 905 connecting the first end edge 901 and the first side edge 926. While only the first corner portion 905 is shown in FIG. 10, each of the second, third, and fourth corner portions 905, 907, 909, 911 (shown in FIG. 9) are substantially identical to the first corner portion 905 shown in FIG. 10.

In the example embodiment, the first corner portion 905 includes a first offset edge 913, a second offset edge 915, and a curved edge 917 extending between the first offset edge 913 and the second offset edge 915. In FIG. 10, the first offset edge 913 and the second offset edge 915 are each shown in broken lines to clearly show these portions relative to the curved edge 917, the first end edge 901, and the first side edge 926, each of which is shown in solid lines.

The first offset edge 913 is linear and extends from the first side edge 926 to the curved edge 917. The first offset edge 913 is oriented obliquely at an obtuse first offset angle θ₁ relative to the first side edge 926. In the example embodiment, the first offset angle θ₁ is 177 degrees. In other words, the first offset edge 913 is oriented to extend inward of the first side edge 926 at an approximately three-degree acute angle offset from the first side edge 926. In other embodiments, the first offset angle θ₁ may be between 100 degrees and 179 degrees.

The second offset edge 915 is linear and extends from the first end edge 901 to the curved edge 917. The second offset edge 915 is oriented obliquely at an obtuse second offset angle θ₂ relative to the first end edge 901. In the example embodiment, the second offset angle θ₂ is the same as the first offset angle θ₁ (i.e., 177 degrees), though in other embodiments, the second offset edge 915 may be oriented at any suitable offset angle θ₂ relative to the first end edge 901 and may in some embodiments be oriented at a different offset angle than the first offset angle θ₁.

The curved edge 917 extends from the first offset edge 913 to the second offset edge 915. In the example embodiment the curved edge 917 has a generally constant curvature along a length of the curved edge 917 extending from the first offset edge 913 to the second offset edge 915. That is a radius of curvature R_{C} of the curved edge 917 defined from a common center point C₁ to the curved edge 917, is constant along the length of the curved edge 917.

Referring back to FIG. 9, the display panel 908 of the example embodiment is configured to be cut in substantially the same manner as described with respect to the display panel 408 to form one or more additional panels from the display panel 908. For example, the display panel 908 may be cut along a lateral midline extending between the first and second side edges 926, 928 (similar to midline M_{L}, shown in FIG. 5) to form a pair of display panels that are half-sections of the display panel 908. Additionally or alternatively, the display panel 908 is configured to be cut along a cut line that extends through an intersection of the first side edge 903 and the first offset edge 913 (shown in FIG. 10), to form a display panel in substantially the same manner as described with respect to display panel 808 (shown in FIG. 8).

Any one of the topper displays 412, 712, and 812 may be used in combination with any other one of the gaming devices 400, 700, and 800 and/or display panels 408, 708, 808, 908. In other embodiments, the topper displays 412, 712, and 812 may have any suitable configuration that enables the gaming devices 400, 700, and 800 to operate as described herein.

Exemplary technical effects of the methods, systems, and apparatus described herein include at least one of: (a) providing a display assembly of a gaming device having at least one curved edge; (b) reduced costs to manufacture displays having curved edges by providing for an ability to cut a template curved display panel for forming sub-display curved panels from the template display panel; (c) improved reliability for display panels cut from a template display panel; (d) reduced overall time required to manufacture curved display panels; and (e) improved display aesthetic for attracting players toward a gaming device.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming device comprising:
a cabinet; and
a display assembly coupled to the cabinet and configured to display a game thereon, wherein the display assembly comprises a display frame and a display panel positioned within the display frame, the display panel comprising:
an outer display surface;
a rear panel layer including a plurality of transistors coupled to a substrate; and
a liquid crystal layer positioned between the rear panel layer and the outer display surface, wherein the outer display surface includes a pair of opposed elongated edges and a first curved edge extending between the elongated edges.

2. The gaming device of claim 1, wherein the first curved edge is coplanar with the elongated edges.

3. The gaming device of claim 1, wherein the display panel includes a rectangular section at least partially defined by the pair of opposed elongated edges and a semicircular section at least partially defined by the first curved edge.

4. The gaming device of claim 1, wherein the display panel has a stadium shaped profile that includes a rectangular section at least partially defined by the pair of opposed elongated edges, a first semicircular section at least partially defined by the first curved edge, and a second semicircular section at least partially defined by a second curved edge of the outer display surface.

5. The gaming device of claim 1, wherein the display panel has a stadium profile and is configured to be cut along a longitudinal midline of the display panel configured for forming a pair of similarly sized display panels from the display panel.

6. The gaming device of claim 1, wherein the display panel has a stadium shaped profile that includes a rectangular section at least partially defined by the pair of opposed elongated edges, a first semicircular section at least partially defined by the first curved edge, and a second semicircular section at least partially defined by a second curved edge of the outer display surface, the second semicircular section having a diameter equal to a width of the rectangular section, wherein the display panel is configured to be cut along the diameter of the second semicircular section.

7. The gaming device of claim 1, wherein the pair of opposed elongated edges includes a first side edge and a second side edge of the outer display surface, the outer display surface further including first and second end edges each extending between the first side edge and the second side edge, the display panel further including a first corner portion connecting the first side edge to the first end edge, the first corner portion including the first curved edge.

8. The gaming device of claim 7, wherein the first curved edge defines an overall length extending between the first side edge and the first end edge, and wherein the first curved edge has a constant curvature along the length of the first curved edge.

9. The gaming device of claim 7, wherein the first corner portion further includes a first offset edge and a second offset edge, the first offset edge extending from the first side edge to the first curved edge and the second offset edge extending from the first curved edge to the first end edge, the first offset edge being obliquely oriented relative to the first side edge and the second offset edge being obliquely oriented relative to the first end edge.

10. The gaming device of claim 1, wherein the liquid crystal layer is operatively connected to a base frame, wherein the base frame is modifiable at one or more sections to excise the one or more sections from the display assembly.

11. The gaming device of claim 1, wherein the display panel has a rounded corner parallelogram shape.

12. The gaming device of claim 1, wherein the rear panel layer comprises a plurality of pixel electrodes coupled to the substrate, and wherein the pixel electrodes are arranged on the substrate to enable cutting of the rear panel layer along a longitudinal midline of the display panel to form at least one operable secondary display panel.

13. A display panel for use with an electronic gaming machine, the display panel comprising:
an outer display surface;
a rear panel layer including a plurality of transistors coupled to a substrate; and
a liquid crystal layer positioned between the rear panel layer and the outer display surface, wherein the outer display surface includes a pair of opposed elongated edges and a first curved edge extending between the elongated edges.

14. The display panel of claim 13, wherein the first curved edge is coplanar with the elongated edges.

15. The display panel of claim 13 further comprising a rectangular section at least partially defined by the pair of opposed elongated edges and a semicircular section at least partially defined by the first curved edge.

16. The display panel of claim 13, wherein the display panel has a stadium shaped profile that includes a rectangular section at least partially defined by the pair of opposed elongated edges, a first semicircular section at least partially defined by the first curved edge, and a second semicircular section at least partially defined by a second curved edge of the outer display surface.

17. The display panel of claim 13, wherein the display panel has a stadium profile and is configured to be cut along a longitudinal midline of the display panel configured for forming a pair of similarly sized display panels from the display panel.

18. A method of forming a display panel for use with an electronic gaming machine, the method comprising:
providing an outer display surface and a rear panel layer, the rear panel layer including a plurality of transistors coupled to a substrate; and
coupling a liquid crystal layer to the rear panel layer and the outer display surface with the liquid crystal layer being positioned between the rear panel layer and the outer display surface, wherein the outer display surface includes a pair of opposed elongated edges and a first curved edge extending between the elongated edges.

19. The method of claim 18, wherein the first curved edge is coplanar with the elongated edges.

20. The method of claim 18, wherein the display panel includes a rectangular section at least partially defined by the pair of opposed elongated edges and a semicircular section at least partially defined by the first curved edge.
